(19) United States
(12) Patent Application Publication
(10) Pub. No.: US 2007/0045545 A1
(43) Pub. Date: Mar. 1, 2007

(54) Hyperspectral sensor using tunable filter

(76) Inventors: David O. Light, Arab, AL (US); Tommy Lum, Madison, AL (US); William C. Pittman, Huntsville, AL (US)

Correspondence Address: Legal Office;AMSAM-L-G-I (Ms. Anne Lanteigne), US Army Aviation and Missile Command, 4th Floor, Building 5300, Redstone Arsenal, AL, 35898-5000, US

(21) Appl. No.: 11/215,204

(22) Filed: Aug. 26, 2005

(51) Int. Cl. G01J 5/02

(52) U.S. Cl. 250/342

(57) ABSTRACT

A target-seeking-and-tracking system featuring hyperspectral sensing performed by a tunable filter and an infrared focal plane array is programmable to collect and process several hyperspectral bands of infrared radiation emanating from a target scenery. The programming is done by tuning the filter from time to time to collect several hyperspectral bands containing image data corresponding to several objects of interest in the scenery. The image data is further processed in the target recognition unit to identify the objects and aid in the selection and tracking of a particular target object for the ultimate goal of accurate destruction of the object. The programmability of hyperspectral sensing provides a degree of countermeasures immunity by allowing several bands to be combined to achieve the best signal-to-clutter ratio.

The invention described herein may be manufactured, used and licensed by or for the Government for governmental purposes without the payment to us of any royalties thereon.

### BACKGROUND OF THE INVENTION

The principal feature of both aircraft and rockets that is rich in information for purposes of object detection and discrimination is the radiation from the propulsion exhaust plume emanating from the aircraft or the rockets. It has been established in principle that two spectral bands in the mid-infrared region, when combined, provide an effective means for the early-warning receivers on missiles to detect and discriminate plume effects of target aircrafts or rockets.

In an infrared radiation profile of a typical missile utilizing the focal plane array to detect a target object, the two spectral bands mentioned above may be designated as the red band and the blue band in a spectrum ranging from 3.5 to 5 microns. The red band lies in the atmospheric window where CO₂ and CO products from the missile plume radiate, spiking at about 4.5 microns. The blue band lies in an area just above the red band, spiking at about 4.3 microns, where atmospheric absorption in the CO₂ band is dominant. The targeted missile's high plume intensity exhibits this blue spike through the absorption band, although at a significantly lower level in comparison to the red spike. This profile is also typical of the combustion process of a non-missile aircraft.

A sensor that can capture images of both the target object and its plume near-simultaneously using several spectral bands against the black body radiation profile of heavy clutter in a given scenery would prove most useful in a missile with an air defense homing seeker. With such a sensor bringing the target object into the foreground of heavy background clutter, it is not necessary to rely exclusively on the plume characteristics for detection and tracking of the target object. It would enhance and render greater reliability to the seeker's ability to detect and discriminate a target object and track the selected target object closely toward its ultimate, accurate destruction.

### SUMMARY OF THE INVENTION

A target-seeking-and-tracking system featuring hyperspectral sensing in conjunction with an infrared focal plane array is programmable to collect, using a tunable filter, several hyperspectral bands of infrared radiation emanating from a target scenery. The several spectral bands yield image data that are indicative of several objects or aspects of the scenery, the objects or aspects corresponding to the wavelengths encompassed in the spectral bands. The image data is further processed in the target recognition unit to identify the objects and aid in the selection and tracking of a particular target object for the ultimate goal of accurate destruction of the object.

The programmability of hyperspectral sensing provides a degree of countermeasures immunity by allowing several bands to be combined to achieve the best signal-to-clutter ratio.

### DESCRIPTION OF THE DRAWING

FIG. 1 shows the configuration of a typical missile in which the hyperspectral sensor may be used.

FIG. 2 is a functional block diagram of sensor 200.

FIG. 3 diagrammatically illustrates the sensor functions.

### DESCRIPTION OF THE PREFERRED EMBODIMENT

Even though the Hyperspectral Sensor Using Tunable Filter (hereinafter referred to as “the sensor”) can be employed in many applications, including the spectrometer, its application in a missile seeker with a target-recognition system resident in it is chosen for the purposes of explaining the sensor's structure and function in detail. Therefore, the sensor's application in a missile should be seen as illustrative only and not as limiting the scope of the invention.

Any and all of the numerical dimensions and values that follow should be taken as nominal values rather than absolutes or as a limitation on the scope of the invention. These nominal values are examples only; many variations in size, shape and types of materials may be used as will readily be appreciated by one skilled in the art as successfully as the values, dimensions and types of materials specifically set forth hereinafter. In this regard where ranges are provided, these should be understood only as guides to the practice of this invention.

Although the term “hyperspectral” may be defined by technically-conversant people in slightly different ways, the following definition applies for the purposes of explaining the invention at hand: “hyperspectral” denotes a continuous sampling along the electromagnetic spectrum to obtain multi-channel, contiguous, narrow spectral band imagery spanning from the visible to the infrared portion of the spectrum. The sampled spectral bands can number in the single digits to hundreds of narrow contiguous bands in equally-spaced steps.

This invention combines the principle of hyperspectral band, mid-infrared detection and discrimination of objects with a mid-infrared focal plane array to enhance the capability of infrared homing missiles that attack aircrafts in heavy background clutter to select accurately and closely track a target object.

Multiple hyperspectral bands of infrared radiation that range approximately between 3.0 and 5.0 microns are collected and image data produced therefrom to enable the distinction between various objects in the target scenery. This takes advantage of the generally established fact of at least the following corresponding indications:
3.0 to 3.5 microns—infrared flares
3.0 to 4.2 microns—solar reflections
4.3 microns—blue spike of missile or aircraft engine plume
4.5 microns—red spike of missile or aircraft engine plume
4.5 to 5 microns—aircraft body heating
   However, long-wave IR (8-14 microns) can also be utilized. It is contemplated that from 2 to approximately a dozen hyperspectral bands would be collected by the sensor in one functional episode.

A tunable filter positioned in the beam path of the incoming infrared radiation is programmed to change rapidly to pass therethrough the multiple spectral bands. This change in the spectral bands occurs on the order of microseconds.

Referring now to the drawing wherein like numbers represent like parts in each of the several figures and, further, arrowheads represent the direction of signal paths, the sensor is presented in detail below.

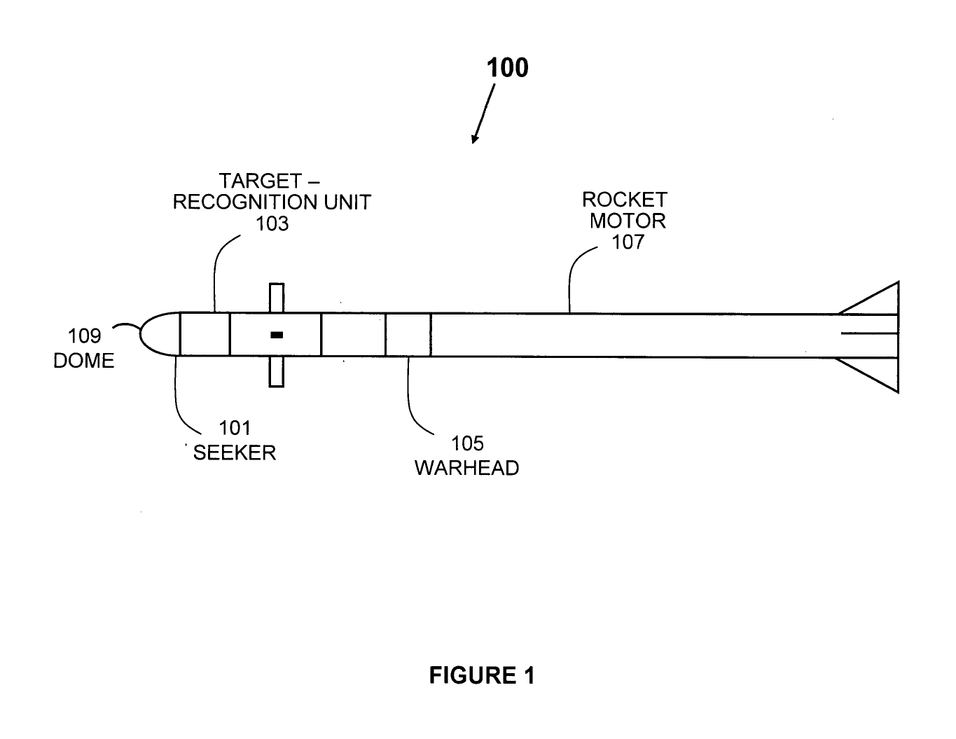

FIG. 1 shows the configuration of typical missile 100 in which the hyperspectral sensor may be used. The missile, among other components, has seeker 101 including dome 109, target-recognition unit 103, warhead 105 and rocket motor 107. The sensor is located in the seeker section and performs in conjunction with the target-recognition unit to produce the end result of x-y coordinates of the target that is selected for tracking and ultimate destruction.

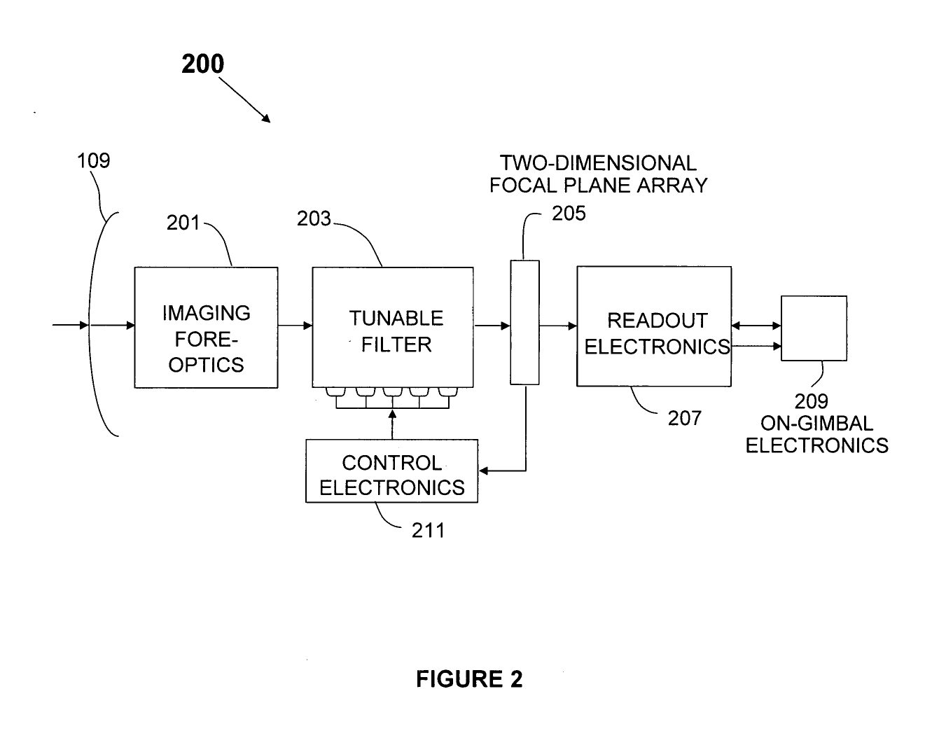

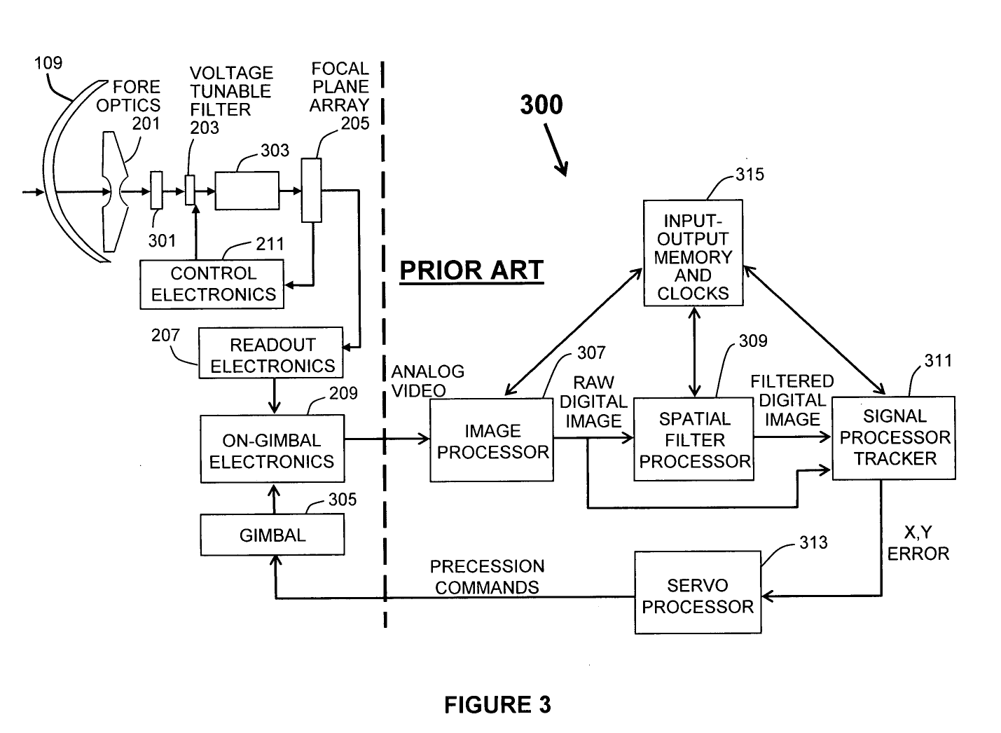

FIG. 2 is a functional block diagram of sensor 200 while FIG. 3 illustrates the sensor functions in relation to the target-recognition unit shown to the right of the heavy dotted line and designated as “prior art.”

The entire sensor 200 may be mounted on gimbal 305 for maximum operational effectiveness.

From various objects or aspects of the selected target scenery (not shown) that may include mobile objects, such as a missile, as well as stationary objects, such as background clutter, infrared radiation (IR) emanates and impinges on imaging fore-optics 201 through dome 109 of missile seeker 101. The fore-optics collects the radiation and focuses it on tunable filter 203. The hyperspectral bands selected to pass through the tunable filter are thereafter incident on focal plane array 205 which converts the IR energy into a two-dimensional image of the hyperspectral IR characteristics of the object from which the IR emanated. The image data (analog video) is read out by read-out electronics 207 and input, via on-gimbal electronics 209, to target-recognition unit 300. Image processing is performed by the target-recognition unit to produce an output which is a pair of x and y dc error voltages corresponding to the track point location of the selected target with respect to the center of the target scenery image (0, 0). The x-y error voltages are then fed to servo processor 313 which converts them to the electrical format required to drive gimbal 305 in the direction of the track point. As the gimbal position is updated in this manner, the track point is gradually forced to the center of the image and the errors go to zero—thus “tracking” the target.

Even though there are several filtering devices that can achieve tenability of narrow bands across the visible and infrared spectrum, only a limited number of them meet the requirements for missile application as contemplated by this invention. The filtering device must be able to capture a two-dimensional image frame at the same instant of time and at the same waveband. It should also be structurally simple and be capable of switching at a high speed.

The preferred filter for missile application is voltage tunable filter 203 (also known as surface plasmon tunable filter) controlled by control electronics 211. The control electronics sequentially changes the dc voltage levels that are input to the filter so as to change the spectral bands of filter 203 sequentially. These sequential changes occur on the order of microseconds. ISOMET Corp., Brimrose Company and NEOS Technologies are some of the sources that can provide filters built to customer specifications.

Voltage tunable filter 203 is designed and built such that certain dc input voltage levels provided by the control electronics correspond to specific hyperspectral bands processed by the filter. The programmability of the voltage-controlled tunability of the filter provides multi-band hyperspectral characterizations of various aspects of target objects; in cases of missiles, the missile body as well as the plume in the mid-infrared region.

The control electronics functions as an electronic regulator between the tunable filter and the focal plane array. In addition to setting the modulation rate of the filter that causes the selected wavelengths of photons to pass therethrough and be incident on the focal play array, the control electronics receives from the focal plane array a feedback signal that monitors the rate at which the photons are being converted to electrical signals for target tracking processing.

Strictly speaking, the energy of an optical wave incident on the voltage tunable filter is absorbed and converted to the energy of oscillating electron energy at surface resonance condition that is defined by the input voltage. However, for ease of reference, this absorption and conversion process is referred to in this application as “filtering” or “passing.”

Another type of tunable filter that may be used for missile applications is the acousto-optical tunable filter (AOTF). AOTF is a crystal device that, when excited with a radio frequency (RF) signal from a microwave controller, produces an internal ultrasonic wave that sets up a moving diffraction grating within the crystal that passes a specific spectral bandwidth. To change the spectral band, the applied RF is changed. AOTF, though better suited for application in spectrometer, can be programmed to activate several bands for simultaneous collection. However, to determine whether to collect multiple spectral bands simultaneously or sequentially to obtain the optimum performance in the sensor in a given situation requires a detailed trade-off analysis of, among other factors, power (required v. available), size, weight and cost of the filters, interface design complexity, speed, timing and data processing capabilities of the missile.

After passing through the tunable filter, the selected infrared hyperspectral band is incident on focal plane array 205 which converts the IR energy into a two-dimensional visible image of the IR characteristics of the object from which the IR energy emanated. Depending on the geometric configuration of the space in which the sensor is to be located and operational, a transfer lens 303 may be necessary to fold the optics chain in that particular geometric configuration. The transfer lens, if used, is to be positioned in the beam path between the tunable filter and the focal plane array and may provide magnification in one-to-one or other ratios.

The sensor may further be supplemented by optical corrector 301 placed in the beam path between fore-optics 201 and tunable filter 203. The corrector makes wavefront correction to assure that the wavefront of the incoming electromagnetic wave is parallel to the focal plane array and that each point of the wavefront touches the focal plane array at the same instant so as to avoid distortion.

The image data is read out from the focal plane array by Read-out electronics 207, which may be an integral part of the focal plane array itself or a stand-alone device, and transmitted via on-gimbal electronics (OGE) 209 to the target-recognition unit 300, shown in FIG. 3 as comprised of image processor 307, spatial filter processor 309, signal processor tracker 311, servo processor 313 and input-output memory and clocks 315.

The on-gimbal electronics, if not an integral part of the focal plane array, may be coupled to the array by a very short wiring harness or wire bonds and to the image processor (which resides in computers on electronic boards) via slip rings or an extended wiring harness to inputs of the hardware architecture of the processors.

The OGE conditions the low level signals prior to transmitting them to the more sophisticated electronics residing within the target-recognition unit. This is necessary to avoid noise corruption. The OGE may also convert the image data signals from analog to digital, or amplify and convert the analog signals to differential voltages and then transmit them to the target recognition unit to perform the analog-to-digital conversion.

Image processor 307 performs analog-to-digital conversion, if not already performed by the OGE, and non-uniformity correction which corrects the IR image for differences in responsivity of the individual detectors within the focal plane array. The image processor may perform additional necessary image functions. Subsequently, spatial filter processor 309 reduces the background in the image and enhances the edges and small targets to help identify potential targets. This filtered image, along with the raw, corrected image, is used by signal processor tracker 311 in a complex set of functions to pick the correct target and select a proper aimpoint on that target. The output is a pair of x and y error voltages that correspond to the track point location with respect to the center of the image (0, 0). The x-y error voltages are then input to servo processor 313 which converts them to the precession commands required to drive gimbal 305 in the direction of the track point. As the gimbal position is thusly updated, the track point is gradually forced to the center of the image and the errors go to zero—“tracking” the target.

Input-output (IO), memory and clock functions 315 assist the various processors of the target-recognition unit to move data efficiently into, out of, and among the processors; and provide the necessary timing functions to drive the processors and to share memory among the processors.

In the Hyperspectral Sensor Using Tunable Filter, as described above, the tunable filter enables gathering instantaneous two-dimensional image frames in multiple hyperspectral bands of interest within the IR spectrum, such as indicative of the target body and associated plume. Since the instantaneous two-dimensional imagery captures both the target and the plume, this avoids the necessity of performing a lead bias computation of plume tracking seekers. These images are, then, transferred to the processors which evaluate the characteristics of each and make logical decisions about tracking the target. The use of multiple bands provides more information to the processors and allows better decision to be made in terms of whether to track a particular target within one or more images of differing spectral bands and where within that target (track point) to track. This results in significantly improved capability in discriminating target objects against background clutter which, in turn, improves countermeasures and enables successful night-time engagements.

Although a particular embodiment and form of this invention has been illustrated, it is apparent that various modifications and embodiments of the invention may be made by those skilled in the art without departing from the scope and spirit of the foregoing disclosure. Accordingly, the scope of the invention should be limited only by the claims appended hereto.

We claim:

1. A programmable hyperspectral sensor for use with an image processor, said sensor collecting infrared radiation emanating from a target scenery in several hyperspectral bands for identifying several objects corresponding to said several hyperspectral bands in said target scenery, said sensor comprising: fore-optics for initially collecting incident infrared radiation; a focal plane array for producing from incident infrared radiation image data pertaining to said corresponding objects; a tunable filter positioned between said fore-optics and said focal plane array, said filter being controlled to pass therethrough infrared radiation of pre-selected spectral bands incident thereon from said fore-optics and forward said radiation of pre-selected hyperspectral bands to said focal plane array; a means for programming said tunable filter so as to enable said filter to pass therethrough various hyperspectral bands from time to time; a means for transmitting said image data to the image processor to be further evaluated as to the infrared characteristics of the imaged objects, thereby enabling more efficient selections of target objects.

2. A programmable hyperspectral sensor as set forth in claim 1, wherein said sensor is mounted on a gimbal, the gimbal being repositionable in response to precession commands received from time to time so as to track more closely a selected object in the target scenery.

3. A programmable hyperspectral sensor as set forth in claim 2, wherein said transmitting means comprises: on-gimbal electronics (OGE), said OGE being coupled between said focal play array and the image processor and performing conditioning of said image data from said array to reduce noise corruption.

4. A programmable hyperspectral sensor as set forth in claim 3, wherein the filtered spectral bands number between 2 and 10 and lie between 3 and 5 microns.

5. A programmable hyperspectral sensor as set forth in claim 3, wherein the filtered spectral bands lie between 8 and 14 microns.

6. A programmable hyperspectral sensor as set forth in claim 4, wherein said tunable filter is a voltage tunable filter and said programming means is control electronics for varying the voltage levels input to said filter, a certain voltage level corresponding to a specific spectral band passed by said voltage tunable filter.

7. A programmable hyperspectral sensor as set forth in claim 4, wherein said tunable filter is an acousto-optic tunable filter and said programming means is a microwave controller for selectively varying the optical frequency of said filter, a certain optical frequency corresponding to a specific spectral band passed by said acousto-optic tunable filter.

8. A programmable hyperspectral sensor as set forth in claim 6, wherein said several spectral bands of infrared radiation are collected in a sequential order, said sequence occurring on the order of microseconds.

9. A programmable hyperspectral sensor as set forth in claim 7, wherein said several spectral bands of infrared radiation are collected simultaneously.

10. In a missile seeker having a target-recognition unit for processing input target image data and producing therefrom the x-y coordinates of a desired target object in a given target scenery so as to enable the missile to track the object more closely for ultimate, accurate destruction of the object; a hyperspectral sensor for gathering infrared radiation in several hyperspectral bands, the several hyperspectral bands being indicative of several corresponding objects in the target scenery, and generating the input target image data from the gathered infrared radiation, said sensor comprising: fore-optics for initially collecting infrared radiation emanating from the target scenery; a focal plane array for producing, from incident infrared radiation, image data pertaining to said corresponding objects; a tunable filter positioned between said fore-optics and said focal plane array, said filter being controlled to pass therethrough infrared radiation of pre-selected several hyperspectral bands incident thereon from said fore-optics and forward said radiation to said focal plane array; a means for controlling said tunable filter; and a means for transmitting said image data to the target-recognition unit for further processing for characterization of objects in the target scenery and selection of a desired target object.

11. In a missile seeker having a target-recognition unit, a hyperspectral sensor as set forth in claim 10, wherein said sensor is mounted on a gimbal, the gimbal being repositionable in response to precession commands received from time to time from said target-recognition unit so as to track more closely said selected target object in the target scenery.

12. In a missile seeker having a target-recognition unit, a hyperspectral sensor as set forth in claim 11, wherein said transmitting means comprises: on-gimbal electronics, said on-gimbal electronics being coupled between said focal plane array and said target-recognition unit and performing conditioning of said image data from said array to reduce noise corruption prior to transmitting said image data to said target-recognition unit.

13. In a missile seeker having a target-recognition unit, a hyperspectral sensor as set forth in claim 12, wherein said sensor further comprises: at least one optical corrector positioned between said fore-optics and said tunable filter for making wavefront correction in said initially-collected infrared radiation so as to cause the wavefront of said radiation to be parallel to said focal plane array.

14. A hyperspectral sensor as set forth in claim 13, wherein said sensor still further comprises: a transfer lens positioned between said tunable filter and said focal plane array, said transfer lens enabling said sensor to fit into and function in a given space of a particular geometric configuration.

15. A hyperspectral sensor as set forth in claim 14, wherein said tunable filter is a voltage tunable filter and said controlling means is control electronics for varying the voltage input to said filter, a certain voltage level corresponding to a specific hyperspectral band passed by said voltage tunable filter.

16. A hyperspectral sensor as set forth in claim 15, wherein the passed hyperspectral bands number between 2 and 10 and lie between 3 and 5 microns.

17. A hyperspectral sensor as set forth in claim 16, wherein said several hyperspectral bands of infrared radiation are collected in a sequential order, said sequence occurring on the order of microseconds.

18. A hyperspectral sensor as set forth in claim 15, wherein the passed hyperspectral bands lie between 8 and 14 microns.

19. A hyperspectral sensor as set forth in claim 14, wherein said tunable filter is an acousto-optic tunable filter and said programming means is a microwave controller for selectively varying the optical frequency of said filter, a certain optical frequency corresponding to a specific hyperspectral band passed by said acousto-optic tunable filter.
